(19) United States
(12) Patent Application Publication
(10) Pub. No.: US 2008/0132192 A1
(43) Pub. Date: Jun. 5, 2008

(54) MULTI-BAND RECEIVER

(75) Inventor: Kyoo Hyun LIM, Gyeonggi-Do (KR)

Correspondence Address: CANTOR COLBURN, LLP, 20 Church Street, 22nd Floor, Hartford, CT, 06103, US

(73) Assignee: FCI INC., Gyeonggi-Do (KR)

(21) Appl. No.: 11/872,744

(22) Filed: Oct. 16, 2007

(30) Foreign Application Priority Data
Oct. 20, 2006 (KR) 10-2006-0102281

(51) Int. Cl. H04B 1/26

(52) U.S. Cl. 455/315

(57) ABSTRACT

A multi-band receiver for converting RF signals in different bands into IF signals in digital multimedia broadcasting (DMB) or digital audio broadcasting (DAB) is provided. The multi-band receiver includes an amplification unit amplifying the at least three RF signals, a voltage controlled oscillator (VCO) generating at least three basic oscillator signals, and an IF signal converting unit converting the at least three RF signals output from the amplification unit into IF signals by using the at least three basic oscillator signals. Each of the at least three basic oscillator signals is constructed with two differential signals having a phase difference of 90 degrees. Accordingly, it is possible to easily design a VCO and reduce the area of the VCO by processing application bands band-II, band-III, and L-band of a DMB system by using one or two VCOs in the multi-band receiver.

This application claims priority to Korean Patent Application No. 10-2006-0102281, filed on Oct. 20, 2006, all the benefits accruing therefrom under 35 U.S.C. §119, the contents of which in their entirety are incorporated herein by reference.

### BACKGROUND OF THE INVENTION

1. Field of the Invention

The present invention relates to a receiver for converting an radio frequency (RF) signal into an intermediate frequency (IF) signal in digital multimedia broadcasting (hereinafter, referred to as ‘DMB’) or digital audio broadcasting (hereinafter, referred to as ‘DAB’), and more particularly, to a terrestrial DMB receiver for supporting multi-band.

2. Description of the Related Art

Frequency bands used by terrestrial digital multimedia broadcasting (DMB) are various. For example, the frequency bands include band-II, band-III, and L-band. Here, the band-II ranges from 88 MHz (Mega Hertz) to 108 MHz. The band-III ranges from 174 MHz to 245 MHz. The L-band ranges from 1452 MHz to 1492 MHz.

The terrestrial DMB receiver serves to mix a multi-band RF signal with an oscillator signal of a voltage controlled oscillator (hereinafter, referred to as ‘VOC’) to generate an IF signal, and select only a frequency of a desirable signal through a band pass filter.

FIG. 1 is a circuit diagram illustrating a conventional multi-band receiver.

Referring to FIG. 1, the conventional multi-band receiver for processing a multi-band signal in the band-II (88˜108 MHz), the band-III (174˜245 MHz), and the L-band (1452˜1492 MHz) includes first to third amplification units, first to third filters, first to third mixers, first to third VCOs, and a band pass filter. First, when an RF signal received through an antenna for band-II (88˜108 MHz) (hereinafter, referred to as ‘first band RF signal’) is provided, the first amplifier amplifies a desirable signal by minimizing noise included in the received signal and controls the gain. In addition, the output of the first amplifier is input into the first filter to remove an image frequency and input into the first mixer. The first mixer mixes the received signal with the oscillator signal output from the first VCO to generate an IF signal.

On the other hand, an RF signal received through an antenna for band-III (174˜245 MHz) (hereinafter, referred to as ‘second band RF signal’) is input into the second mixer through the second amplifier and the second filter and mixed with the oscillator signal output from the second VCO to generate a desirable IF signal. An RF signal received through an antenna for L-band (1452˜1492 MHz) (hereinafter, referred to as ‘third band RF signal’) is input into the third mixer through the third amplifier and the third filter and mixed with the oscillator signal output from the third VCO to generate a desirable IF signal.

The generated IF signal passes through the band pass filter so as to remove an image frequency. The band pass filter allows only the frequency of the desirable signal to be selected within a narrow bandwidth, so as to accurately select a channel.

As described above, in the conventional multi-band receiver, since VCOs for processing the first to third band RF signals are separately constructed, the structure of the conventional multi-band receiver is complex. Since independent buffers are needed for the VCOs, power consumption is large.

### SUMMARY OF THE INVENTION

The present invention provides a multi-band receiver that is a terrestrial digital multimedia broadcasting (DMB) receiver capable of processing RF signals in different bands by using a voltage controlled oscillator (VCO) or two VCOs.

According to an aspect of the present invention, there is provided a multi-band receiver including an amplification unit 204, a VCO 202, and an IF signal converter 205.

The amplification unit 204 may serve to remove noise from first to third band RF signals (band-II to L-band) and amplify the first to third band RF signals by automatically controlling the gain. The VCO 202 may generate first to third band basic oscillator signals VCO1 to VCO3 corresponding to first to third band RF signals (band-II, band-III, and L-band). The IF signal converter 205 may convert the first to third band RF signals (band-II, band-III, and L-band) output from the amplification unit 204 into IF signals by using the first to third band basic oscillator signals VCO1 to VCO3. Each of the first to third band basic oscillator signals VCO1 to VCO3 may be constructed with two differential signals having a phase difference of 180 degrees from each other.

According to another aspect of the present invention, there is provided a multi-band receiver including an amplification unit 305, first and second VCOs 302 and 303, and an IF signal converter 306.

The amplification unit 305 may serve to remove noise from first to third band RF signals (band-II to L-band) and amplify the first to third band RF signals by automatically controlling the gain. The first VCO 302 may generate first and second band basic oscillator signals VCO4 and VCO5 corresponding to first and second band RF signals (band-II and band-III). The second VCO 303 may generate a third band basic oscillator signal VCO6 corresponding to a third band RF signal (L-band). The IF signal converter 306 may convert the first to third band RF signals (band-II, band-III, and L-band) output from the amplification unit 305 into IF signals by using the first to third band basic oscillator signals VCO4 to VCO6. Each of the first to third band basic oscillator signals VCO4 to VCO6 may be constructed with two differential signals having a phase difference of 180 degrees from each other.

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram illustrating a conventional multi-band receiver;

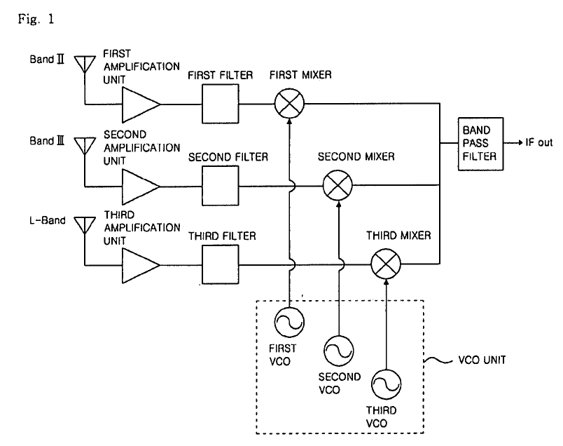

FIG. 2 is a block diagram illustrating a multi-band receiver according to a first embodiment of the present invention; and

FIG. 3 is a block diagram illustrating a multi-band receiver according to a second embodiment of the present invention.

### DETAILED DESCRIPTION OF THE INVENTION

Hereinafter, exemplary embodiments of the present invention will be described in detail with reference to the attached drawings. When description of the known techniques or structures related to the present invention is unnecessary, the detailed description will be omitted.

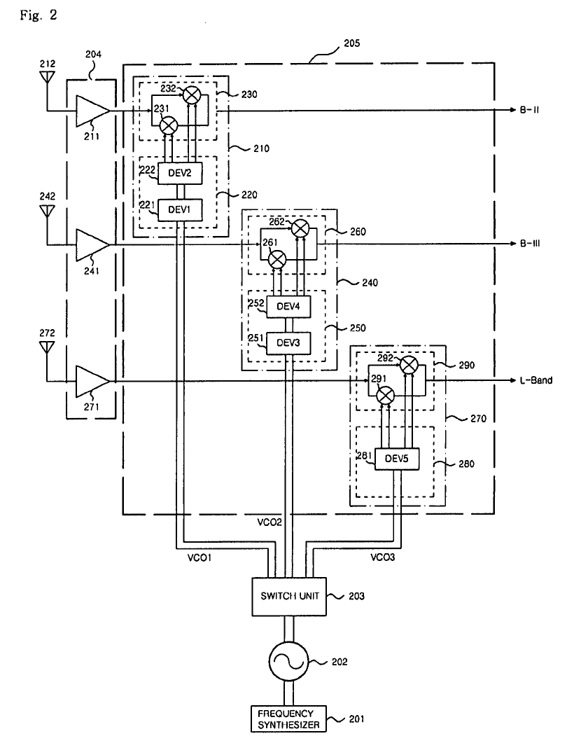

FIG. 2 is a block diagram illustrating a multi-band receiver according to a first embodiment of the present invention.

Referring to FIG. 2, the multi-band receiver according to the first embodiment of the present invention includes an amplification unit 204, a voltage controlled oscillator (VCO) 202, a switch unit 203, and an intermediate frequency (IF) signal converting unit 205.

The amplification unit 204 includes first to third amplifiers 211, 241, and 271. The first amplifier 211 amplifies only a desirable signal by minimizing noise included in a first band RF signal received through a band-II antenna 212 and automatically controls the gain. The output of the first amplifier 211 is connected to the IF signal converter 205. The second amplifier 241 amplifies only a desirable signal by minimizing noise included in a second band RF signal received through a band-III antenna 242 and automatically controls the gain. The output of the second amplifier 241 is connected to the IF signal converter 205. The third amplifier 271 amplifies only a desirable signal by minimizing noise included in a third band RF signal received through an L-band antenna 272 and automatically controls the gain. The output of the third amplifier 271 is connected to the IF signal converter 205.

The VCO 202 generates first to third band basic oscillator signals VCO1 to VCO3 (band-II to L-band) used to convert first to third band RF signals into IF signals. Each of the first to third band basic oscillator signals VCO1 to VCO3 is constructed with two differential signals having a phase difference of 180 degrees from each other.

The IF signal converting unit includes first to third band IF signal converting units 210, 240, and 270.

The first band IF signal converting unit 210 serves to convert the amplified first band RF signal into the first band IF signal by using the first band basic oscillator signal VCO1. The first band IF signal converting unit 210 includes a first frequency division unit 220 and a first mixing unit 230. The first frequency division unit 220 outputs four first-band local oscillator signals LO1 with phase differences of 90 degrees from one another by dividing the frequency of the first band basic oscillator signal VCO1. The first frequency division unit 220 includes first and second frequency dividers 221 and 222. The first frequency divider 221 divides the frequency of the first band basic oscillator signal VCO1 by sixteen. The second frequency divider 222 divides the frequency of the signal output from the first frequency divider 221 by two. The first mixing unit 230 mixes the amplified first band RF signal output from the amplification unit 204 with the first-band local oscillator signal LO1 output from the first frequency division unit 220 to generate the first band IF signal. The first mixing unit 230 includes first and second mixers 231 and 232. The first and second mixers 231 and 232 mixes two first-band local oscillator signals LO1 having a phase difference of 180 degrees from each other received from the first frequency division unit 220 with the first band RF signal. The two first-band local oscillator signals LO1 to be mixed by the first mixer 231 have phase differences of 90 degrees from the two first-band local oscillator signals LO1 to be mixed by the second mixer 232.

The second band IF signal converting unit 240 serves to convert the amplified second band RF signal into a second band IF signal by using the second band basic oscillator signal VCO2. The second band IF signal converting unit 240 includes a second frequency division unit 250 and a second mixing unit 260. The second frequency division unit 250 outputs four second-band local oscillator signals LO2 with phase differences of 90 degrees from one another by dividing the frequency of the second band basic oscillator signal VCO2. The second frequency division unit 250 includes third and fourth frequency divider 251 and 252. The third frequency divider 251 divides the frequency of the second band basic oscillator signal VCO2 by eight. The fourth frequency divider 252 divides the frequency output from the third frequency divider 251 by two. The second mixing unit 260 mixes the amplified second band RF signal output from the amplification unit 204 with the second-band local oscillator signal LO2 output from the second frequency division unit 250 to generate the second band IF signal. The second mixing unit 260 includes first and second mixers 261 and 262. The first and second mixers 261 and 262 mixes two second-band local oscillator signals LO2 having a phase difference of 180 degrees from each other received from the second frequency division unit 250 with the second band RF signal. The two second-band local oscillator signals LO2 to be mixed by the first mixer 261 have phase differences of 90 degrees from the two second-band local oscillator signals LO2 to be mixed by the second mixer 262.

The third band IF signal converting unit 270 serves to convert the amplified third band RF signal into a third band IF signal by using the third band basic oscillator signal VCO3. The third band IF signal converting unit 270 includes a third frequency division unit 280 and a third mixing unit 290. The third frequency division unit 280 outputs four third-band local oscillator signals LO3 with phase differences of 90 degrees from one another by dividing the frequency of the third band basic oscillator signal VCO3. The third frequency division unit 280 includes fifth frequency divider 281. The fifth frequency divider 281 divides the frequency of the third band basic oscillator signal VCO3 by two. The third mixing unit 290 mixes the amplified third band RF signal output from the amplification unit 204 with the third-band local oscillator signal LO3 output from the third frequency division unit 280 to generate the third band IF signal. The third mixing unit 290 includes first and second mixers 291 and 292. The first and second mixers 291 and 292 mixes two third-band local oscillator signals LO3 having a phase difference of 180 degrees from each other received from the third frequency division unit 280 with the third band RF signal. The two third-band local oscillator signals LO3 to be mixed by the first mixer 291 have phase differences of 90 degrees from the two third-band local oscillator signals LO3 to be mixed by the second mixer 292.

The frequency of the first band basic oscillator signal VCO1 ranges from 2816 MHz to 3456 MHz. The frequency of the second band basic oscillator signal VCO2 ranges from 2784 MHz to 3920 MHz. The frequency of the third band basic oscillator signal VCO3 ranges from 2904 MHz to 2984 MHz.

The multi-band receiver according to the embodiment may further include a frequency synthesizer 201 synthesizing and transmitting a signal with a predetermined frequency to the VCO 202.

The multi-band receiver according to the embodiment may further include a switch unit 203 switching and transmitting the first to third band basic oscillator signals VCO1 to VCO3 output from the VCO 202 to the IF signal converting unit 205.

As described above, the first-band local oscillator signal LO1 for the band-II (88˜108 MHz) is generated by dividing the frequency of the first band basic oscillator signal VCO1 by 32. The second-band local oscillator signal LO2 for the band-III (174˜245 MHz) is generated by dividing the frequency of the second band basic oscillator signal VCO2 by sixteen. The third-band local oscillator signal LO3 for the L-band (1452˜2984 MHz) is generated by dividing the frequency of the third band basic oscillator signal VCO3 by two.

It will be understood by those skilled in the art that it is possible to apply the present invention to a multi-band having three or more bands by using a VCO without departing from the spirit and scope of the invention by suitably selecting a basic oscillator signal and a frequency divider used to divide the frequency of the basic oscillator signal.

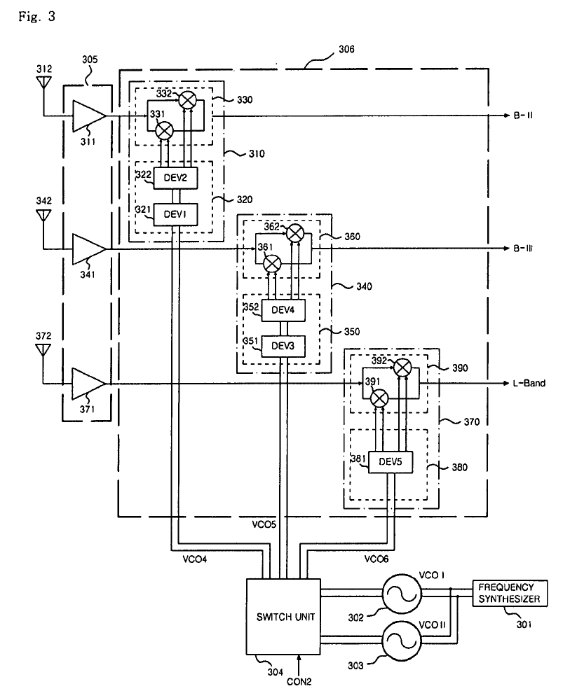

FIG. 3 is a block diagram illustrating a multi-band receiver according to a second embodiment of the present invention.

Referring to FIG. 3, the multi-band receiver according to the second embodiment of the present invention includes an amplification unit 305, first and second VCOs 302 and 303, and an IF signal converting unit 306.

The amplification unit 305 includes first to third amplifiers 311, 341, and 371. The first amplifier 311 amplifies only a desirable signal by minimizing noise included in a first band RF signal received through a band-II antenna 312 and automatically controls the gain. The output of the first amplifier 311 is connected to the IF signal converting unit 306. The second amplifier 341 amplifies only a desirable signal by minimizing noise included in a second band RF signal received through a band-III antenna 342 and automatically controls the gain. The output of the second amplifier 341 is connected to the IF signal converting unit 306. The third amplifier 371 amplifies only a desirable signal by minimizing noise included in a third band RF signal received through an L-band antenna 372 and automatically controls the gain. The output of the third amplifier 371 is connected to the IF signal converting unit 306.

The first VCO 302 generates first and second band basic oscillator signals VCO1 and VCO2 (band-II and band-III) used to convert first and second band RF signals into IF signals. The second VCO 303 generates a third band basic oscillator signal VCO6 used to convert a third band RF signal (band-III) into an IF signal. Each of the first to third band basic oscillator signals VCO4 to VCO6 is constructed with two differential signals having a phase difference of 180 degrees from each other.

The IF signal converting unit 306 includes first to third band IF signal converting units 310, 340, and 370.

The first band IF signal converting unit 310 serves to convert the amplified first band RF signal into the first band IF signal by using the first band basic oscillator signal VCO4. The first band IF signal converting unit 310 includes a first frequency division unit 320 and a first mixing unit 330. The first frequency division unit 320 outputs four first-band local oscillator signals LO1 with phase differences of 90 degrees from one another by dividing the frequency of the first band basic oscillator signal VCO4. The first frequency division unit 320 includes first and second frequency divider 321 and 322. The first frequency divider 321 divides the frequency of the first band basic oscillator signal VCO4 by eight. The second frequency divider 322 divides the frequency of the signal output from the first frequency divider 321 by two. The first mixing unit 330 mixes the amplified first band RF signal output from the amplification unit 305 with the first-band local oscillator signal LO1 output from the first frequency division unit 320 to generate the first band IF signal. The first mixing unit 330 includes first and second mixers 331 and 332. The first and second mixers 331 and 332 mixes two first-band local oscillator signals LO1 having a phase difference of 180 degrees from each other received from the first frequency division unit 320 with the first band RF signal. The two first-band local oscillator signals LO1 to be mixed by the first mixer 331 have phase differences of 90 degrees from the two first-band local oscillator signals LO1 to be mixed by the second mixer 332.

The second band IF signal converting unit 340 serves to convert the amplified second band RF signal into a second band IF signal by using the second band basic oscillator signal VCO5. The second band IF signal converting unit 340 includes a second frequency division unit 350 and a second mixing unit 360. The second frequency division unit 350 outputs four second-band local oscillator signals LO2 with phase differences of 90 degrees from one another by dividing the frequency of the second band basic oscillator signal VCO5. The second frequency division unit 350 includes third and fourth frequency divider 351 and 352. The third frequency divider 351 divides the frequency of the second band basic oscillator signal VCO5 by four. The fourth frequency divider 352 divides the frequency output from the third frequency divider 351 by two. The second mixing unit 360 mixes the amplified second band RF signal output from the amplification unit 305 with the second-band local oscillator signal LO2 output from the second frequency division unit 350 to generate the second band IF signal. The second mixing unit 360 includes first and second mixers 361 and 362. The first and second mixers 361 and 362 mixes two second-band local oscillator signals LO2 having a phase difference of 180 degrees from each other received from the second frequency division unit 350 with the second band RF signal. The two second-band local oscillator signals LO2 to be mixed by the first mixer 361 have phase differences of 90 degrees from the two second-band local oscillator signals LO2 to be mixed by the second mixer 362.

The third band IF signal converting unit 370 serves to convert the amplified third band RF signal into a third band IF signal by using the third band basic oscillator signal VCO6. The third band IF signal converting unit 370 includes a third frequency division unit 380 and a third mixing unit 390. The third frequency division unit 380 outputs four third-band local oscillator signals LO3 with phase differences of 90 degrees from one another by dividing the frequency of the third band basic oscillator signal VCO6. The third frequency division unit 380 includes fifth frequency divider 381. The fifth frequency divider 381 divides the frequency of the third band basic oscillator signal VCO6 by two. The third mixing unit 390 mixes the amplified third band RF signal output from the amplification unit 305 with the third-band local oscillator signal LO3 output from the third frequency division unit 380 to generate the third band IF signal. The third mixing unit 390 includes first and second mixers 391 and 392. The first and second mixers 391 and 392 mixes two third-band local oscillator signals LO3 having a phase difference of 180 degrees from each other received from the third frequency division unit 380 with the third band RF signal. The two third-band local oscillator signals LO3 to be mixed by the first mixer 391 have phase differences of 90 degrees; from the two third-band local oscillator signals LO3 to be mixed by the second mixer 392.

The frequency of the first band basic oscillator signal VCO4 ranges from 1408 MHz to 1728 MHz. The frequency of the second band basic oscillator signal VCO5 ranges from 1392 MHz to 1960 MHz. The frequency of the third band basic oscillator signal VCO3 ranges from 2904 MHz to 2984 MHz.

The multi-band receiver according to an embodiment of the present invention may further include a frequency synthesizer 301 synthesizing a signal with a predetermined frequency and transmitting to the first and second VCOs 302 and 303.

The multi-band receiver according to an embodiment of the present invention may further include a switch unit 304 switching the first to third band basic oscillator signals VCO4 to VCO6 output from the first and second VCOs 302 and 303 and transmitting to the IF signal converter 306.

As described above, the first-band local oscillator signal LO1 for the band-II (88˜108 MHz) is generated by dividing the frequency of the first band basic oscillator signal VCO4 by sixteen. The second-band local oscillator signal LO2 for the band-III (174˜245 MHz) is generated by dividing the frequency of the second band basic oscillator signal VCO5 by eight. The third-band local oscillator signal LO3 for the L-band (1452˜2984 MHz) is generated by dividing the frequency of the third band basic oscillator signal VCO6 by two.

It will be understood by those skilled in the art that it is possible to apply the present invention to a multi-band having three or more bands by using two VCOs without departing from the spirit and scope of the invention by suitably selecting a basic oscillator signal and a frequency divider used to divide the frequency of the basic oscillator signal.

In addition, the multi-band receiver for converting an RF signal into an IF signal according to an embodiment of the present invention may be applied to a case where the frequency of the IF signal is zero, in addition to a case where the frequency of the IF signal is greater than zero. That is, it will be understood by those skilled in the art that the multi-band receiver according to an embodiment of the present invention may be applied to a case where the frequency of the IF signal is zero, that is, a case of direct conversion by slightly modifying the multi-band receiver.

It is possible to easily design a VCO and reduce the area of the VCO by processing application bands band-II, band-III, and L-band of a DMB system by using one or two VCOs in the multi-band receiver according to an embodiment of the present invention. Since one VCO is used, independent buffer ends are not needed, thereby reducing power consumption. In addition, since a signal with a frequency higher than that of the conventional signal used for the multi-band is generated by the VCO and used, unnecessary interference due to the signal is reduced. It is possible to improve a phase noise characteristic by using a plurality of frequency dividers. In addition, when using two VCOs, it is possible to easily design the VCOs and to reduce the area of each VCO by selecting a suitable frequency divider in a range in which frequency coverage is not high.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A multi-band receiver converting at least three RF (radio frequency) signals into IF (intermediate frequency) signals, the multi-band receiver comprising:
an amplification unit amplifying the at least three RF signals;
a voltage controlled oscillator (VCO) generating at least three basic oscillator signals VCO1 to VCO3; and
an IF signal converting unit converting the at least three RF signals output from the amplification unit into IF signals by using the at least three basic oscillator signals VCO1 to VCO3,
wherein each of the at least three basic oscillator signals VCO1 to VCO3 is constructed with two differential signals having a phase difference of 180 degrees from each other.

2. The multi-band receiver of claim 1,
wherein the at least three RF signals include first to third band RF signals, and
wherein the amplification unit includes:
a first amplifier amplifying the first band RF signal;
a second amplifier amplifying the second RF signal; and
a third amplifier amplifying the third RF signal.

3. The multi-band receiver of claim 2,
wherein the at least three RF signals include first to third band basic oscillator signals, and
wherein the IF signal converting unit includes:
a first band IF signal converting unit converting the amplified first band RF signal (band-II) into a first band IF signal by using the first band basic oscillator signal VCO1;
a second band IF signal converting unit converting the amplified second band RF signals (band-III) into a second band IF signal by using the second band basic oscillator signal VCO2; and
a third band IF signal converting unit converting the amplified third band RF signals (L-band) into a third band IF signal by using the third band basic oscillator signal VCO3.

4. The multi-band receiver of claim 3, wherein the first band IF signal converting unit includes:
a first frequency division unit outputting four first-band local oscillator signals LO1 with phase differences of 90 degrees from one another by dividing the frequency of the first band basic oscillator signal VCO1; and
a first mixing unit mixing the amplified first band RF signal output from the amplification unit with the first-band local oscillator signal LO1 output from the first frequency division unit to generate the first band IF signal.

5. The multi-band receiver of claim 4, wherein the first frequency division unit 220 includes:
a first frequency division unit dividing the frequency of the first band basic oscillator signal VCO1 by sixteen; and
a second frequency division unit dividing the frequency of the signal output from the first frequency divider by two.

6. The multi-band receiver of claim 4,
wherein the first mixing unit includes:
a first mixer mixing two first-band local oscillator signals LO1 having a phase difference of 180 degrees from each other received from the first frequency division unit with the first band RF signal; and
a second mixer mixing two first-band local oscillator signals LO1 having a phase difference of 180 degrees from each other received from the first frequency division unit with the first band RF signal, and
wherein the two first-band local oscillator signals LO1 to be input into the first mixer have phase differences of 90 degrees from the two first-band local oscillator signals LO1 to be input into the second mixer.

7. The multi-band receiver of claim 3, wherein the second band IF signal converting unit includes:
a second frequency division unit outputting four second-band local oscillator signals LO2 with phase differences of 90 degrees from one another by dividing the frequency of the second band basic oscillator signal VCO2; and
a second mixing unit mixing the amplified second band RF signal output from the amplification unit with the second-band local oscillator signal LO2 output from the second frequency division unit to generate the second band IF signal.

8. The multi-band receiver of claim 7, wherein the second frequency division unit includes:
a third frequency divider dividing the frequency of the second band basic oscillator signal VCO2 by eight; and
a fourth frequency divider dividing the frequency output from the third frequency divider by two.

9. The multi-band receiver of claim 7,
wherein the second mixing unit includes:
a first mixers mixing two second-band local oscillator signals LO2 having a phase difference of 180 degrees from each other received from the second frequency division unit with the second band RF signal; and
a second mixer mixing two second-band local oscillator signals LO2 having a phase difference of 180 degrees from each other received from the second frequency division unit with the second band RF signal, and
wherein the two second-band local oscillator signals LO2 to be mixed by the first mixer have phase differences of 90 degrees from the two second-band local oscillator signals LO2 to be mixed by the second mixer.

10. The multi-band receiver of claim 3, wherein the third band IF signal converting unit includes:
a third frequency division unit outputting four third-band local oscillator signals LO3 with phase differences of 90 degrees from one another by dividing the frequency of the third band basic oscillator signal VCO3; and
a third mixing unit mixing the amplified third band RF signal output from the amplification unit with the third-band local oscillator signal LO3 output from the third frequency division unit to generate the third band IF signal.

11. The multi-band receiver of claim 10, wherein the third frequency division unit includes a fifth frequency divider dividing the frequency of the third band basic oscillator signal VCO3 by two.

12. The multi-band receiver of claim 10,
wherein the third mixing unit includes:
a first mixer mixing two third-band local oscillator signals LO3 having a phase difference of 180 degrees from each other received from the third frequency division unit with the third band RF signal; and
a second mixer mixing two third-band local oscillator signals LO3 having a phase difference of 180 degrees from each other received from the third frequency division unit with the third band RF signal, and
wherein the two third-band local oscillator signals LO3 to be mixed by the first mixer have phase differences of 90 degrees from the two third-band local oscillator signals LO3 to be mixed by the second mixer.

13. The multi-band receiver of claim 1, wherein the frequency of the first band basic oscillator signal VCO1 ranges from 2816 MHz to 3456 MHz, the frequency of the second band basic oscillator signal VCO2 ranges from 2784 MHz to 3920 MHz, and the frequency of the third band basic oscillator signal VCO3 ranges from 2904 MHz to 2984 MHz.

14. The multi-band receiver of claim 1, further comprising a frequency synthesizer synthesizing and transmitting a signal with a predetermined frequency to the VCO.

15. The multi-band receiver of claim 1, further comprising a switch unit switching and transmitting the first to third band basic oscillator signals VCO1 to VCO3 output from the VCO to the IF signal converting unit.

16. A multi-band receiver converting at least three RF (radio frequency) signals into IF signals, the multi-band receiver comprising:
an amplification unit amplifying the at least three RF signals;
a first voltage controlled oscillator (VCO) generating at least two basic oscillator signals; and
a second VCO generating at least one basic oscillator signal; and
an IF signal converting unit converting the at least three RF signals into IF signals by using the at least three basic oscillator signals,
wherein each of the at least three basic oscillator signals VCO4 to VCO6 is constructed with two differential signals having a phase difference of 180 degrees from each other.

17. The multi-band receiver of claim 16,
wherein the at least three RF signals include first to third band RF signals, and
wherein the amplification unit includes:
a first amplifier amplifying the first band RF signal;
a second amplifier amplifying the second RF signal; and
a third amplifier amplifying the third RF signal.

18. The multi-band receiver of claim 16,
wherein the at least three RF signals include first to third band basic oscillator signals, and
wherein the IF signal converting unit includes:
a first band IF signal converting unit converting the amplified first band RF signal (band-II) into a first band IF signal by using the first band basic oscillator signal VCO4;
a second band IF signal converting unit converting the amplified second band RF signals (band-III) into a second band IF signal by using the second band basic oscillator signal VCO5; and
a third band IF signal converting unit converting the amplified third band RF signals (L-band) into a third band IF signal by using the third band basic oscillator signal VCO6.

19. The multi-band receiver of claim 18, wherein the first band IF signal converting unit includes:
a first frequency division unit outputting four first-band local oscillator signals LO1 with phase differences of 90 degrees from one another by dividing the frequency of the first band basic oscillator signal VCO4; and
a first mixing unit mixing the amplified first band RF signal output from the amplification unit with the first-band local oscillator signal LO1 output from the first frequency division unit to generate the first band IF signal.

20. The multi-band receiver of claim 19, wherein the first frequency division unit includes:
a first frequency division unit dividing the frequency of the first band basic oscillator signal VCO4 by eight; and
a second frequency division unit dividing the frequency of the signal output from the first frequency divider by two.

21. The multi-band receiver of claim 19,
wherein the first mixing unit includes:
a first mixer mixing two first-band local oscillator signals LO1 having a phase difference of 180 degrees from each other received from the first frequency division unit with the first band RF signal; and
a second mixer mixing two first-band local oscillator signals LO1 having a phase difference of 180 degrees from each other received from the first frequency division unit with the first band RF signal, and
wherein the two first-band local oscillator signals LO1 to be mixed by the first mixer have phase differences of 90 degrees from the two first-band local oscillator signals LO1 to be mixed by the second mixer.

22. The multi-band receiver of claim 18, wherein the second band IF signal converting unit includes:
a second frequency division unit outputting four second-band local oscillator signals LO2 with phase differences of 90 degrees from one another by dividing the frequency of the second band basic oscillator signal VCO5; and
a second mixing unit mixing the amplified second band RF signal output from the amplification unit with the second-band local oscillator signal LO2 output from the second frequency division unit to generate the second band IF signal.

23. The multi-band receiver of claim 22, wherein the second frequency division unit includes:
a third frequency divider dividing the frequency of the second band basic oscillator signal VCO5 by four; and
a fourth frequency divider dividing the frequency output from the third frequency divider by two.

24. The multi-band receiver of claim 22,
wherein the second mixing unit includes:
a first mixers mixing two second-band local oscillator signals LO2 having a phase difference of 180 degrees from each other received from the second frequency division unit with the second band RF signal; and
a second mixer mixing two second-band local oscillator signals LO2 having a phase difference of 180 degrees from each other received from the second frequency division unit with the second band RF signal, and
wherein the two second-band local oscillator signals LO2 to be mixed by the first mixer have phase differences of 90 degrees from the two second-band local oscillator signals LO2 to be mixed by the second mixer.

25. The multi-band receiver of claim 18, wherein the third band IF signal converting unit includes:
a third frequency division unit outputting four third-band local oscillator signals LO3 with phase differences of 90 degrees from one another by dividing the frequency of the third band basic oscillator signal VCO6; and
a third mixing unit mixing the amplified third band RF signal output from the amplification unit with the third-band local oscillator signal LO3 output from the third frequency division unit to generate the third band IF signal.

26. The multi-band receiver of claim 25, wherein the third frequency division unit includes a fifth frequency divider dividing the frequency of the third band basic oscillator signal VCO6 by two.

27. The multi-band receiver of claim 25,
wherein the third mixing unit includes:
a first mixer mixing two third-band local oscillator signals LO3 having a phase difference of 180 degrees from each other received from the third frequency division unit with the third band RF signal; and
a second mixer mixing two third-band local oscillator signals LO3 having a phase difference of 180 degrees from each other received from the third frequency division unit with the third band RF signal, and
wherein the two third-band local oscillator signals LO3 to be mixed by the first mixer have phase differences of 90 degrees from the two third-band local oscillator signals LO3 to be mixed by the second mixer.

28. The multi-band receiver of claim 16, wherein the frequency of the first band basic oscillator signal VCO4 ranges from 1408 MHz to 1728 MHz, the frequency of the second band basic oscillator signal VCO5 ranges from 1392 MHz to 1960 MHz, and the frequency of the third band basic oscillator signal VCO6 ranges from 2904 MHz to 2984 MHz.

29. The multi-band receiver of claim 16, further comprising a frequency synthesizer synthesizing and transmitting a signal with a predetermined frequency to the first and second VCOs

30. The multi-band receiver of claim 16, further comprising a switch unit switching and transmitting the first to third band basic oscillator signals VCO4 to VCO6 output from the first and second VCOs to the IF signal converting unit.
